(19) United States
(12) Patent Application Publication
(10) Pub. No.: US 2008/0115995 A1
(43) Pub. Date: May 22, 2008

(54) ANTI-LOCK BRAKE

(76) Inventor: Ronald A. Holland, Orange, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/870,230

(22) Filed: Oct. 10, 2007

Related U.S. Application Data
(60) Provisional application No. 60/859,653, filed on Nov. 17, 2006.

(51) Int. Cl. B62D 61/08

(52) U.S. Cl. 180/216; 180/215

(57) ABSTRACT

A brake is provided on a vehicle. The vehicle includes two drive wheels on two independent drive axles, respectively. The drive wheels are attached to the outside ends of the drive axles. Both drive wheels and drive axles (e.g., left and right) rotate on about the same axis as one another. On each drive axle, a brake disc is attached close to the inside end of the drive axle. A friction element (e.g., a brake friction material disc) is provided between the two brake discs. A brake device (e.g., brake caliper) is coupled to the frame of the vehicle. When the brake is applied, the brake device exerts a clamping force on the discs.

### PRIORITY CLAIM

This application claims priority to U.S. Provisional Patent Application Ser. No. 60/859,653 filed on Nov. 17, 2006, entitled “ANTI-LOCK BRAKE”, the disclosure of which is hereby incorporated by reference.

### BACKGROUND

1. Field of the Invention

The present invention relates in general to brake systems for vehicles, and more particularly to an improved apparatus and method for providing anti-lock braking for vehicle with three or more wheels.

2. Description of Related Art

Anti-lock brakes are especially important to the safety of three wheel vehicles, either the single wheel in the front or the single wheel in the rear versions. If one of the two wheels in the front or one of the two wheels in the rear lock-up on a three wheel vehicle while braking at high speed an unbalanced force is created that could cause the vehicle to turn over. Three wheel vehicles are generally smaller and less expensive than four wheel vehicles.

There is a need for a simple, less expensive anti-locking brake for vehicles, such as on the two-wheel end of a three-wheel vehicle.

### SUMMARY

Various embodiments of vehicles, brake systems, and methods of braking vehicles are presented. In one embodiment, a brake is provided on a three-wheel vehicle. A single wheel is provided for steering in the front of the vehicle and two independent drive wheels are provided in the rear on two independent drive axles, respectively. The drive wheels are attached to the outside ends of the drive axles. Both drive wheels and drive axles (e.g., left and right) rotate on the same axis as one another. On each drive axle, a brake disc is attached close to the inside end of the drive axle. A friction element (e.g., a brake friction material disc) is provided between the two brake discs. A brake device (e.g., brake caliper) is coupled to the frame of the vehicle. The brake device is located over the brake discs and the friction element in a braking orientation. When the brake is applied, the brake device exerts a clamping force on the discs. Under the clamping force, frictional torque between the two brake discs is increased. Increased torque of a faster-moving axle on a slower-moving axle of the two axles tends to inhibit the slower-moving axle from locking up (e.g., during braking when the vehicle is turning, or when one of the wheels is on ice, etc.) In some embodiments, neither of the two wheels will lock up and slide without the other under heavy braking conditions.

In an embodiment, left and right drive axles on a vehicle are flexible. For example, each of the left and right drive axles can include two universal joints. The innermost portions of the left and right axles (e.g., the portions between left and right inboard universal joints) are rotatably mounted on the same axis. A brake device (e.g., caliper) engages (e.g., clamps) brake discs at the inner ends of the axles. The brake device applies a force to the brake discs. Torque from a faster-moving axle of the two axles tends to inhibit a slower-moving drive axle from locking up without the other.

In an embodiment, left and right drive axles are mounted on the front end of a vehicle. Each of the left and right drive axles are flexible (e.g., having at least one universal joint). The inner portions of the left and right axles (e.g., the portions between left and right universal joints) are rotatably mounted on the same axis. Brake discs are attached to each drive axle close to the inside ends of the drive axles. A brake device operates to clamp the brake discs together. Frictional torque between the two drive axles tends to inhibit a slower-moving drive axle from locking Up without the other.

### BRIEF DESCRIPTION OF THE DRAWINGS

Advantages of the present invention will become apparent to those skilled in the art with the benefit of the following detailed description and upon reference to the accompanying drawings in which:

FIG. 1 is a top view illustration of a three-wheeled vehicle including an anti-lock brake system according to one embodiment.

FIG. 2 is a side view illustration of a three-wheeled vehicle including an anti-lock brake system according to one embodiment.

FIG. 3 is an illustration of an anti-lock brake system according to one embodiment.

FIG. 4 is an illustration of how an anti-lock brake system may be applied to a vehicle with flexible drive axles according to one embodiment.

FIG. 5 is a side view illustration of a four-wheeled vehicle with front and rear anti-lock brake systems according to one embodiment.

FIG. 6 is a top view illustration of a four-wheeled vehicle with front and rear anti-lock brake systems according to one embodiment.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

In a first preferred embodiment, an anti-lock brake is provided on a three-wheel vehicle. A single wheel is provided for steering in the front of the vehicle and two independent drive wheels in the rear on two independent drive axles respectively. The drive wheels are fixedly attached to the outside ends of the drive axles and both the wheels and the axles rotate on the same axis.

In the first preferred embodiment, the inside ends of the axles overlap so that one runs on a bearing inside the other. A brake disc is fixedly attached to each axle close to the exposed inside ends. The discs are placed just far enough apart so that a thin piece of frictional braking material in the form of a disc can be slipped between them and held in place by one of the axles. The caliper portion of the disc brake is firmly attached to the frame of the vehicle. The caliper portion of the disc brake is located over the three discs in a braking orientation.

When the vehicle is moving and the brakes are applied, the normal force on each disc from the pads in the caliper is about the same, therefore if the pads are both made of the same material and have the same coefficient of friction, the braking force on each wheel will be about the same. But the surface on which the wheels are rolling is not always the same, therefore one of the two wheels might start to skid, which would make it try to rotate slower than the non-skidding wheel. The frictional material between the two discs has an equal normal force applied to it from the caliper through the two pads, which creates a frictional torque between the two discs and may cause the wheel that is not skidding to turn the other wheel. With the help of whatever frictional force is available from the road surface the two wheels can remain turning at the same speed, and lock-up of a single wheel can be avoided, which will allow the vehicle to come to a quick, safe stop.

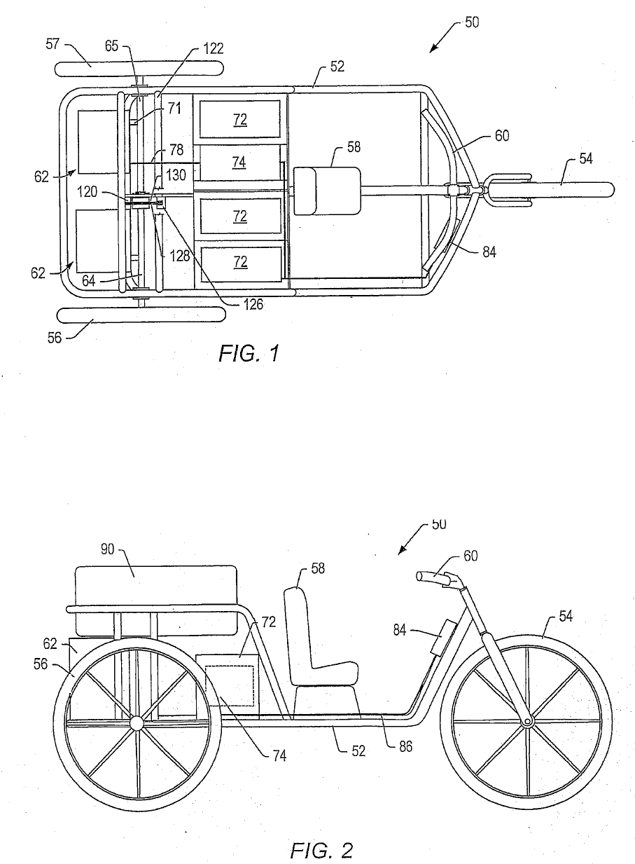

FIGS. 1 and 2 depict a three-wheeled vehicle having multiple drive units and an anti-lock brake system according to one embodiment. Vehicle 50 includes frame 52, front wheel 54, and rear wheels 56 and 57. Seat 58 is attached to frame 52. Steering bar 60 is coupled to front wheel 54. Steering bar 60 is operable to turn front wheel 54 left and right.

The two axles 64 and 65 is rotatably mounted in frame 52 and fixedly mounted on their outer ends in rear wheels 56 and 57, respectively.

Vehicle 50 includes brake 120. Brake 120 is coupled to rear axles 64 and 65. Brake 120 is operable to brake vehicle 50. Brake 120 can, in some embodiments, be an anti-lock brake. Brake 120 includes brake caliper 126. One of the upper members 122 of frame 52 is cut-away for illustration of brake caliper 126. Brake caliper 126 is mounted on frame 52 around brake discs 128 and 130. Brake caliper 126 has a suitable orientation for use as a brake. Vehicle 50 includes drive systems 62. Drive systems 62 are coupled to axles 64 and 65 through final drive unit 71. Final drive unit 71 can be, for example, a chain connecting drive system 62 to a sprocket on the axle. Rear wheels 56 and 57 are coupled to one of axles 64 and 65, respectively.

Brake disc can be made of many materials. Brake discs can be made of thermally conductive materials to promote rejection of heat produced during braking. In one embodiment, a brake disc is made of steel.

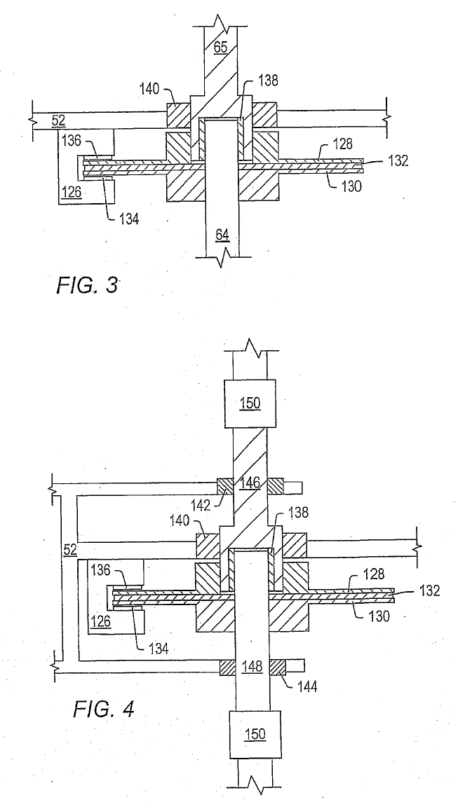

FIG. 3 is a cross-section view of the brake system of FIGS. 1 and 2 illustrating how the axles and the brake parts are mounted in frame 52, according to one embodiment. The inner end of axle 65 can be expanded and supported in frame 52 by ball bearing 140. Bushing 138 can be pressed into the hollow end of axle 65 to support axle 64 on the same axis of rotation as axle 65 and to allow for a small amount of rotation between the two axles when the vehicle is in a turning mode. In one embodiment, bushing 138 is sintered bronze. The hub of brake disc 128 is fixedly mounted just slightly over the inner end of axle 65. The hub of brake disc 130 is mounted on axle 64 so that disc 130 is firmly pressed up against brake disc 128. Brake friction material disc 132 is placed between brake disc 128 and brake disc 130. When brake caliper 126 is actuated, brake pads 134 and 136 clamps down on both sides of the three discs 128, 130, and 132. Clamping of brake pads 134 and 136 produces a braking torque that is about equal in each of the wheels 56 and 57. In this embodiment, the normal force between the brake pads and each of the discs is always about equal. The materials and construction (including, for example, surface roughness) of discs 128, 130, and 132 can be selected such that the coefficient of friction between disc 132 and either disc 128 or 130 is equal to or greater than the coefficient of friction between brake pad 134 and disc 130 or brake pad 136 and disc 128. With this arrangement, one of wheels 56 or 57 will not turn faster than the other even under severe road conditions.

A second preferred embodiment of an anti-lock brake is the same as the first except that the vehicle has a suspension system on the two rear drive wheels. Two universal joints are installed in each of the rear axles. Two extra bearings are provided (one on each axle assembly) to keep the inside ends turning on the same axis. With the ends of the axles on a common axis, the same brake system used on the first preferred embodiment can be used on this embodiment.

FIG. 4 is a cross-section view of the brake system of FIG. 1 and 2 illustrating how the brake system can be applied to a vehicle with flexible drive axles. The brake mechanism in this illustration is the same as that in FIG. 2 but axles 146 and 148 are flexible because they are equipped with universal joints. Axles 146 and 148 include inboard universal joint 150. In some embodiments, axles include both inboard and outboard axles. The non-flexible inner ends of shafts 146 and 148 are rotatably mounted on a common axis in frame 52 by bearings 140, 142, and 144. All other functions of this brake system are the same as that of the embodiment shown in FIG. 3.

Each drive axle can be driven by a separate power source through a chain drive or equivalent with the driven member attached to the inner end of the axle close to the hub of brake disc 128 or 130. The power source could be an electric drive unit, a human powered drive unit, or a combination thereof.

Referring again to FIG. 1, batteries 72 and electronic control unit (ECU) 74 are coupled to drive systems 62. In some embodiments, a drive system includes a lower speed drive unit and a higher speed drive unit. Drive systems turn rear axles 64 and 65 and rear wheels 56 and 57. Rotation of rearwheels 56 and 57 will move vehicle 50 on a road surface.

Batteries 72 are coupled to drive units in drive system 62. Batteries 72 include one or more cells. Batteries 72 supply electrical power to drive units. ECU 74 regulates voltage from batteries 72 to the drive units.

In some embodiments, each drive system and/or wheel location includes speed sensors. Speed sensors are connected to ECU 74 with suitable cables and wiring. Speed sensors provide speed data (e.g., velocity data, acceleration data) to ECU 74. ECU 74 use speed data from speed sensors in regulating power to drive systems 62.

Control panel 84 is connected to ECU 74 through cable 86 (see FIG. 2). Control panel 84 is operable by a driver in seat 58. Brake 120 is controlled through control panel 84 or a separate brake control system. Suitable controls for a vehicle include knobs, foot pedals, switches, dials, levers, and other manual control devices. Vehicles can include brake system 120 coupled to rear axles 64 and 65.

Cargo container 90 is attached to frame 52 (cargo container is omitted from FIG. 1 for clarity). Cargo container 90 supports or contains various objects and/or material that are to be transported in vehicle 50. In some embodiments, a vehicle includes passenger seating instead of, or in addition to, cargo container 90.

Speed sensors can include, for example, a magnet attached to a rotating shaft in a drive system a magnetic pickup attached to a fixed member in the drive system (e.g., attached to the frame). Speed sensors can send electrical pulses to the ECU. In some embodiments, hub motors include Hall sensors. Signals from the Hall sensors are used to determine the speed of the vehicle. In certain embodiments, speed data from speed sensors is used in controlling braking of a vehicle.

A third preferred embodiment of an anti-lock brake uses the same axles and braking system as the second preferred embodiment, but on the front end of a vehicle. The outboard universal joints provide the ability to steer the front wheels. The vehicle is equipped with front-end suspension and/or front wheel independent drive. The technology of the second and third embodiment combined may provide an inexpensive and very effective anti-lock braking system for a full suspension, independent four-wheel drive vehicle.

In one embodiment a vehicle has 2 front wheels and 1 rear wheel. In another embodiment, a vehicle has two front and two rear wheels.

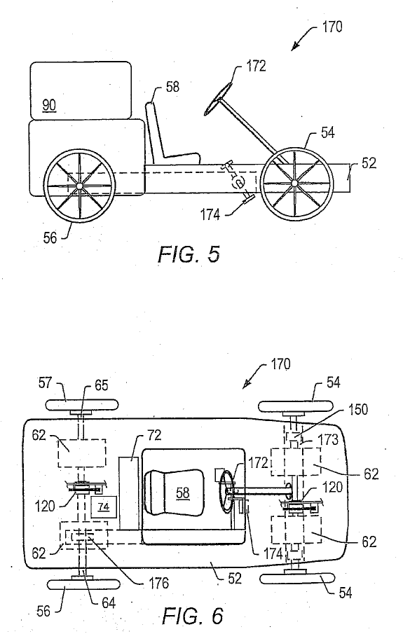

FIGS. 5 and 6 depict a four-wheel vehicle having front and rear brake systems according to one embodiment. Vehicle 170 includes frame 52, front wheels 54, and rear wheels 56 and 57. Seat 58 is coupled to frame 52. Steering wheel 172 is coupled to front wheels 54 through steering linkage assembly 173. Steering wheel 172 is operable to turn front wheels 54 left and right. Drive systems 62 are coupled to frame 52. A drive system 62 is operable to drive each of front wheels 54 and rear wheels 56 and 57. Universal joints 150 are provided on each the front axles to provide steering capability.

Brakes 120 are provided on each of the front and rear axle pairs. Brakes 120 can be individually controlled or commonly controlled. Brakes can be controlled manually, automatically, or a combination thereof.

Pedal crank 174 is coupled to rear axle 64 through clutch device 176. Clutch device 176 may be, for example, a sprag or freewheel. Clutch device 176 can allow the motors to be operated and drive the vehicle without operating pedal crank 174. Alternatively, pedals can be operated at the same time the electric motors are driving a drive shaft. Pedaling during operation of the electric drive system is used to augment power or speed of the vehicle, for example, during hill climbing. In one embodiment, a pedal system is geared to provide power to a vehicle at low speeds (e.g., for extra hill-climbing power). In one embodiment, a rider operates a pedal system to reduce loads on a drive system accelerating from a standing start. In certain embodiments, an ECU for a drive system automatically maintains a drive unit within an acceptable efficiency range (e.g., by varying the voltage to a motor of a drive unit). A rider simultaneously operates a pedal system coupled to the drive system.

Although in FIGS. 5 and 6 drive systems are shown for each of the four wheels, drive systems can in other embodiments be arranged in other combinations. As an example, a vehicle can include a differential that drives both left and right axles on the front of a vehicle. As another example, a vehicle can include one drive system that drives front and rear left wheels, and another drive system that drives front and rear right wheels.

In an embodiment, the inside ends of the left and right axles of a vehicle concentrically overlap.

In an embodiment, a brake of a vehicle includes a left brake disc coupled to the left axle; a right brake disc coupled to the right axle; a caliper configured to engage the brake discs; and a friction disc between the left and right brake discs.

In an embodiment, a brake of a vehicle includes a friction element between a pair of brake discs.

In an embodiment, a brake includes a first brake disc; a second brake disc; a friction element between the first brake disc and the second brake disc; and a brake device configured to apply at least a pair of opposing forces to the brake discs, wherein the friction element is clamped between the first and second brake discs.

As used herein, “vehicle” includes any apparatus for transporting persons, objects, materials, or other things from one place to another. A vehicle can have any number and combination of wheels, tracks, rollers, skids, or other devices for moving on a surface. A vehicle can be directed with a steering wheel, joystick, handlebars, or other control device. Different drive wheels of a vehicle can be commonly controlled by a single control device (e.g., a steering wheel) or by different devices (e.g., a left joystick for a left wheel and a right joystick for a right wheel.) A vehicle can be controlled locally (e.g., by a rider) or remotely. A vehicle can be controlled manually, automatically, or a combination thereof. Vehicles described herein can be used in many applications, including cargo, utility, or transportation. For example, a vehicle can be used as a taxi or tour vehicle. An “electric powered vehicle” is a vehicle that is at least partially driven using electrical power. Electric powered vehicles can be partially driven by sources other than electricity (as with, for a example, a hybrid vehicle).

As used herein, “drive unit” refers to a mechanism or system that imparts motion (e.g., rotation) to a shaft, wheel, gear, sprocket, or other mechanical output device. Suitable drive sources for a drive unit include electric motors, pedal cranks, and hand cranks.

As used herein, “road surface” means any surface on which a vehicle travels. A road surface can be paved, unpaved, outdoors (e.g., a highway), or indoors (e.g., a floor in a warehouse).

As used herein, a “friction element” refers to an element that interacts with another element by way of friction. A friction element can be made of brake friction material or other suitable material. Suitable materials for a friction element include ceramics, metals, and organic materials. Suitable shapes for a friction element can include a disc, a ring, a square plate, or an irregular shape. In certain embodiments, a friction element is a stand-alone element. In certain embodiments, a friction element is attached or integral to another element, such as a brake disc.

As used herein, a “jack-shaft” refers to an intermediate shaft that receives power from at least one source through belts, gearing, or the like, and transmits the power through belts, gearing, or the like to other driven members.

As used herein, “coupled” includes directly coupled or indirectly coupled. As used herein, “connected” or “connection” includes a direct connection or an indirect connection.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials can be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. As used herein, the words “include”, “including”, and “includes” mean including, but not limited to.

What is claimed is:

1. A vehicle, comprising:
a first wheel assembly comprising a first wheel and a first axle;
a second wheel assembly comprising a second wheel and a second axle;
a first brake disc coupled to the first axle;
a second brake disc coupled to the second axle;
a friction element between the first brake disc and the second brake disc; and
a brake device configured to apply at least a pair of opposing forces to the brake discs, wherein the friction element is clamped between the first and second brake discs.

2. The vehicle of claim 1, wherein one wheel of the two wheels will not lock-up and slide without the other during braking.

3. The vehicle of claim 1, wherein the at least opposing forces increase a frictional torque between the first brake disc and the second brake disc.

4. The vehicle of claim 1, wherein the brake device comprises a caliper device.

5. The vehicle of claim 1, wherein the brake device is configured to apply a substantially normal force to each of the first brake disc and the second brake disc.

6. The vehicle of claim 1, wherein the brake device comprises:
a caliper;
a first pad coupled to the caliper; and
a second pad coupled to the caliper and opposing the first pad,
the first pad being configured to contact the first brake disc, the second pad being configured to contact the second brake disc.

7. The vehicle of claim 1, wherein the inboard portion of one of the axles rotates concentrically within a portion of the other axle.

8. The vehicle of claim 1, wherein the drive axles are rotatably mounted at their inner ends to a frame of the vehicle on a substantially common axis.

9. The vehicle of claim 1, wherein the brake discs are configured to engage the friction element to increase a frictional torque between the brake discs when the opposing forces are applied to the brake discs.

10. The vehicle of claim 1, wherein a frictional torque between the frictional element and one or more of the brake discs increases as the normal force on the brake discs increases.

11. The vehicle of claim 1, wherein a coefficient of friction between the first brake disc and the friction element and a coefficient of friction between the second brake disc and the friction element are each equal to or greater than a coefficient of friction between at least one of:
the first pad and the first brake disc; and
the second pad and the second brake disc.

12. The vehicle of claim 1, wherein the first brake disc is configured to, when the brake device is operated, apply a torque generated by the first wheel to the second brake disc to inhibit the second wheel from skidding on a road surface.

13. The vehicle of claim 1, further comprising at least one universal joint, wherein the universal joint coupled to the drive system.

14. The vehicle of claim 1, wherein the first wheel assembly and the second wheel assembly are on the front of the vehicle.

15. The vehicle of claim 1, wherein the first wheel assembly and the second wheel assembly are on the rear of the vehicle.

16. A vehicle, comprising:
a left wheel assembly comprising a left wheel and a left axle;
a right wheel assembly comprising a right wheel and a right axle;
a right axle coupled to the right wheel, the right axle having an axis of rotation substantially aligned with an axis of rotation of the left axle, the right axle and the left axle being configured to rotate at different velocities from one another;
at least one drive system coupled to one of the wheel assemblies; and
a brake coupled to the left axle and the light axle and configured to apply a braking force to the left and right axles, the brake being further configured to transmit torque from one of the axles to the other axle when the brake is operated.

17. The vehicle of claim 16, wherein the torque transmitted from one of the axles to the other axle inhibits the wheel coupled to the other of the axles from skidding on a road surface.

18. The vehicle of claim 16, wherein at least one drive system comprises a left drive system coupled to the left wheel assembly and a right drive system coupled to the right wheel assembly.

19. The vehicle of claim 16, wherein at least one of the drive systems comprises an electric drive unit configured to drive one of the axles.

20. The vehicle of claim 16, wherein at least one of the drive units comprises at least two electric drive units configured to drive one of the axles.
